(19) United States
(12) Patent Application Publication
(10) Pub. No.: US 2025/0131859 A1
(43) Pub. Date: Apr. 24, 2025

(54) FLOATING ELECTRONIC DISPLAY BOARD USING AERIAL VEHICLE

(71) Applicant: This Inc., Gwangmyeong-si (KR)

(72) Inventor: Jong Woong PARK, Bucheon-si (KR)

(21) Appl. No.: 18/615,020

(22) Filed: Mar. 25, 2024

(30) Foreign Application Priority Data
Oct. 23, 2023 (KR) 10-2023-0141785

(51) Int. Cl. G09F 21/14; B64U 70/83; B64U 101/24; G09F 9/33

(52) U.S. Cl. CPC G09F 21/14; B64U 70/83; G09F 9/33; B64U 2101/24

(57) ABSTRACT

The present invention relates to a floating electronic display board using an aerial vehicle, and more particularly, to a floating electronic display board using an aerial vehicle, including: at least two aerial vehicles capable of operating in an unmanned manner, in which a communication module, a GPS, and a power supply device are mounted, configured to interwork with a user terminal through the communication module, and capable of moving up, down, left, and right in midair according to manipulation of a user through the user terminal or a preset flight path; a power supply unit installed in one region of the aerial vehicle to apply a power to the power supply device; and a display unit coupled to a lower portion of the aerial vehicle, electrically connected to the communication module of the aerial vehicle, and configured to receive an electric power from the power supply device to output content.

### BACKGROUND OF THE INVENTION

### 1. Field of the Invention

The present invention relates to a technology for outputting advertisements and content in large spaces such as stadiums, golf courses, theme parks, and performance halls by using aerial vehicles such as drones, airships, and balloons, and more particularly, to a floating electronic display board using an aerial vehicle, in which a lightweight large electronic display board is coupled to a remotely-controlled or autonomously-flying unmanned aerial vehicle so as to be arranged in midair, so that an advertisement and content may be output in the midair within a large space.

### 2. Description of the Related Art

In general, large electronic display boards used to output advertisements and content in large spaces such as stadiums, golf courses, theme parks, and performance halls have been implemented by forming a large electronic display board by arranging a plurality of LED panels having a predetermined size on a rooftop or a wall of a building in a horizontal direction or a vertical direction.

Since the large electronic display board is fixedly installed in one location, in order to expose the advertisements and the content output from the large electronic display board to many audiences, a plurality of display units have to be connected to each other to allow the electronic display board to have a large size so that high expense may be required for facility maintenance, and since the large electronic display board is installed in a fixed location, the advertisements and the content output from the large electronic display board may not be effectively exposed.

Accordingly, in an effort to the above problems, Korean Unexamined Patent Publication No. 10-2018-0055348 has disclosed a technology regarding an outdoor advertisement system capable of inexpensively and freely displaying an advertisement image by maintaining a predetermined distance between a projection drone that projects the advertisement image and a screen drone that unfolds a screen.

However, according to the related art described above, the projection drone that projects a holographic image and the screen drone that unfolds the screen have to be separately provided, locations of the projection drone and the screen drone have to be maintained at the predetermined distance in order to project the holographic image to the screen drone by using the projection drone, and it was difficult to play an advertisement with a holographic image having desired quality when the locations of the drones are changed by an external environment.

### SUMMARY OF THE INVENTION

The present invention has been created to solve the problems described above, and one object of the present invention is to provide a floating electronic display board using an aerial vehicle, in which a large electronic display board is coupled to a remotely-controlled or autonomously-flying unmanned aerial vehicle so as to be arranged in midair, so that one floating electronic display board may be formed, and thus an advertisement and content may be smoothly output in the midair within a large space.

In addition, another object of the present invention is to provide an electronic display board in which a lightweight electronic display board is provided by using a display having a mesh structure, so that the electronic display board may float in midair without restricting flight of an aerial vehicle by a weight of the display coupled to the aerial vehicle or limiting a size of the display.

To achieve the objects described above, according to one embodiment of the present invention, there is provided a floating electronic display board using an aerial vehicle capable of operating in an unmanned manner, the floating electronic display board including: at least two aerial vehicles capable of operating in an unmanned manner, in which a communication module, a GPS, and a power supply device are mounted, configured to interwork with a user terminal through the communication module, and capable of moving up, down, left, and right in midair according to manipulation of a user through the user terminal or a preset flight path; a power supply unit installed in one region of the aerial vehicle to apply a power to the power supply device; and a display unit coupled to a lower portion of the aerial vehicle, electrically connected to the communication module of the aerial vehicle, and configured to receive an electric power from the power supply device to output content.

In addition, according to one embodiment of the present invention, there is provided a floating electronic display board using an aerial vehicle having a balloon shape, the floating electronic display board including: at least two aerial vehicles in which a communication module, a GPS, and a power supply device are mounted, configured to interwork with a user terminal through the communication module, and having a balloon shape so as to be filled with a gas so that the aerial vehicle is able to float in midair; a cable configured to fix the aerial vehicle such that the aerial vehicle is spaced apart from a ground by a preset distance, and coupled between the ground and the aerial vehicle to apply an external power to the power supply device from the ground; and a display unit coupled to a lower portion of the aerial vehicle, electrically connected to the communication module of the aerial vehicle, and configured to receive an electric power from the power supply device to output content.

The display unit may preferably include: a mesh member including a frame having a preset size, and having a mesh structure in which a plurality of vertical lines and a plurality of horizontal lines having conductivity intersect each other at a preset interval within the frame to form a plurality of grid points; an LED module coupled to each of the grid points formed in the mesh member; and a control module connected to the communication module of the aerial vehicle, and configured to receive content data from the communication module to control output of the content data to the LED module.

The display unit may preferably further include: a plurality of weight objects coupled to a bottom portion of the mesh member at a preset interval so as to absorb a vibration generated in the display unit when the display unit floats in the midair.

The mesh member may be preferably formed of at least one conductive fiber among a metal fiber, a nanofiber, a conductive metal compound fiber, and a conductive polymer fiber.

The display unit may preferably further include: at least two aerial vehicle fastening parts formed on an upper portion of the mesh member at equidistant intervals based on an entire length of the upper portion of the mesh member such that a number of the aerial vehicle fastening parts corresponds to a number of the aerial vehicles, when two aerial vehicles are provided, the aerial vehicles may be preferably coupled to two aerial vehicle fastening parts formed at both ends of the upper portion of the mesh member, respectively, so that the display unit floats in the midair, and when more than two aerial vehicles are provided, the aerial vehicles may be preferably coupled to aerial vehicle fastening parts formed on the upper portion of the mesh member at equidistant intervals such that a number of the aerial vehicle fastening parts corresponds to the number of the aerial vehicles, respectively, so that the display unit floats in the midair.

The floating electronic display board may preferably further include: a safety device provided on the aerial vehicle and the display unit to prevent a fall accident of at least one of the aerial vehicle and the display unit.

The safety device may preferably include: a parachute compressed by an elastic device, and accommodated in a housing; an atmospheric pressure sensor configured to measure an altitude of the aerial vehicle or the display unit; and an acceleration sensor configured to measure an acceleration of the aerial vehicle or the display unit, and the safety device may be preferably configured to detect a fall of the aerial vehicle or the display unit through measurement values of the atmospheric pressure sensor and the acceleration sensor, and unfold the parachute when the altitude measured through the atmospheric pressure sensor reaches a preset altitude.

The user terminal may be preferably configured to control the aerial vehicle and the display unit by communicating with the communication module mounted in the aerial vehicle, and the user terminal may preferably include: a content control unit configured to perform control to transmit content data, which is to be output from the display unit, to the communication module; a power control unit configured to control a power of the display unit by controlling the power supply device mounted in the aerial vehicle; and a flight control unit configured to set a flight path and manipulate the flight path of the aerial vehicle in real time by controlling the GPS mounted in the aerial vehicle.

The user terminal may be preferably configured to control the display unit by communicating with the communication module mounted in the aerial vehicle, and the user terminal may preferably include: a content control unit configured to transmit content data, which is to be output from the display unit, to the communication module; and a power control unit configured to control a power of the display unit by controlling the power supply device mounted in the aerial vehicle.

According to a floating electronic display board using an aerial vehicle of the present invention, a large electronic display board may be coupled to a remotely-controlled or unmanned aerial vehicle so as to be autonomously-flying arranged in midair, so that an advertisement and content can be output in the midair within a large space, and thus the electronic display board can be exposed without space restrictions, which can allow a plurality of persons to be effectively exposed to the advertisement and the content output from the electronic display board, thereby enabling smooth information transmission.

In addition, according to one embodiment of the present invention, a lightweight electronic display board may be provided by using a display having a mesh structure, so that flight of an aerial vehicle can be prevented from being restricted by a weight of the display coupled to the aerial vehicle, a size of the display can be prevented from being limited, or the display can be prevented from being separated to fall from the aerial vehicle.

### BRIEF DESCRIPTION OF THE DRAWINGS

FIG. 1 shows an example of a schematic shape of a floating electronic display board using an aerial vehicle capable of operating in an unmanned manner according to one embodiment of the present invention.

FIG. 2 shows an example of a schematic shape of a mesh member of a display unit according to one embodiment of the present invention.

FIGS. 3 and 4 show an example of a state in which a safety device is provided on the floating electronic display board using the aerial vehicle capable of operating in the unmanned manner according to one embodiment of the present invention.

FIG. 5 shows an example of a schematic shape of a floating electronic display board using an aerial vehicle having a balloon shape according to one embodiment of the present invention.

FIGS. 6 and 7 show an example of a state in which a safety device is provided on the floating electronic display board using the aerial vehicle having the balloon shape according to one embodiment of the present invention.

FIG. 8 is a block diagram showing the floating electronic display board using the aerial vehicle capable of operating in the unmanned manner, which is controlled through a user terminal, according to one embodiment of the present invention.

FIGS. 9 to 11 show examples of controlling the aerial vehicle and a display unit through a user terminal according to one embodiment of the present invention.

FIG. 12 is a block diagram showing the floating electronic display board using the aerial vehicle having the balloon shape, which is controlled through a user terminal, according to one embodiment of the present invention.

FIG. 13 shows one example of an internal configuration of a computing device according to one embodiment of the present invention.

### DETAILED DESCRIPTION OF THE INVENTION

Hereinafter, various embodiments and/or aspects will be disclosed with reference to the drawings. In the following description, for the purpose of description, numerous specific an details are set forth in order to facilitate overall understanding of one or more aspects. However, it will also be appreciated by a person having ordinary skill in the art to which the present invention pertains that such aspect(s) may be practiced without the specific details. The following description and the accompanying drawings will be set forth in detail for specific illustrative aspects among the one or more aspects. However, the aspects are provided for illustrative purposes, some of various schemes based on principles of various aspects may be employed, and descriptions set forth herein are intended to include all the aspects and equivalents thereof.

The terms “embodiment”, “example”, “aspect”, “illustration”, and the like used herein may not be construed as indicating that any aspect or design set forth herein is preferable or advantageous over other aspects or designs.

In addition, it is to be understood that the terms “include” and/or “comprise” indicate the presence of corresponding features and/or elements, but do not preclude the presence or addition of one or more other features, elements, and/or groups thereof.

In addition, although the terms including ordinal numbers such as “first” and “second” may be used to describe various elements, the elements are not limited by the terms. The above terms are used merely for the purpose of distinguishing one element from another element. For example, a first element may be termed as a second element, and similarly, a second element may also be termed as a first element without departing from the scope of the present invention. The term “and/or” includes any combination of a plurality of described relevant items, or one of the described relevant items.

In addition, unless defined otherwise, all terms used in embodiments of the present invention, including technical and scientific terms, have the same meaning as those commonly understood by a person having ordinary skill in the art to which the present invention pertains. Any terms as those defined in generally used dictionaries are to be interpreted to have the meanings consistent with the contextual meanings in the relevant field of art, and are not to be interpreted to have idealistic or excessively formalistic meanings unless explicitly defined in the embodiments of the present invention.

The present invention relates to a floating electronic display board using an aerial vehicle. In particular, one object of the present invention is to provide a floating electronic display board using an aerial vehicle, in which a large electronic display board is coupled to a remotely-controlled or autonomously-flying unmanned aerial vehicle so as to be arranged in midair, so that an advertisement and content may be output in the midair within a large space, and another object of the present invention is to provide an electronic display board in which a lightweight electronic display board is provided by using a display having a mesh structure, so that the electronic display board may float in midair without restricting flight of an aerial vehicle by a weight of the display coupled to the aerial vehicle or limiting a size of the display.

For a more detailed description, the present invention will be described below with reference to the accompanying drawings, and a plurality of drawings may be simultaneously referenced in order to describe one technical feature and one element constituting the invention.

Meanwhile, in the following description, although some components shown in the drawings have been omitted or excessively enlarged or reduced in order to describe a function of each of the components of the present invention, it is to be understood that the details shown in the drawings do not limit the technical features and scope of the present invention.

In addition, in the following description, a plurality of drawings may be simultaneously referenced in order to describe one technical feature or one element constituting the invention.

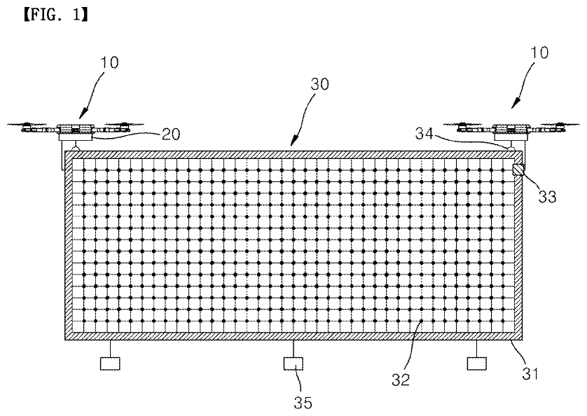

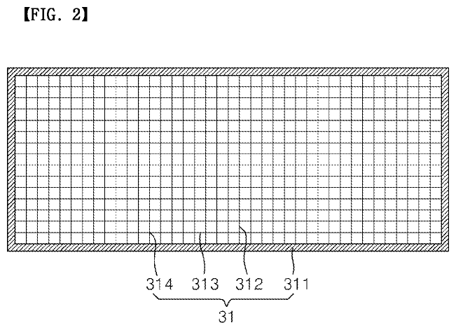

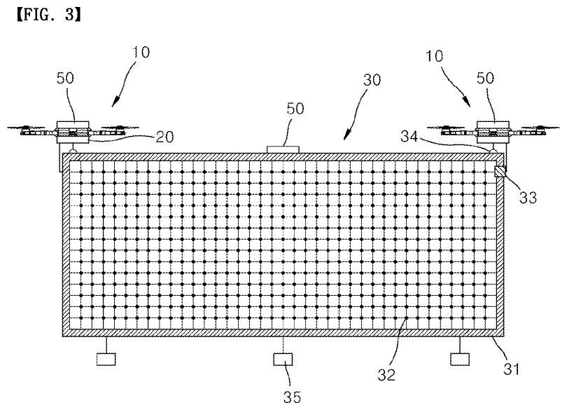

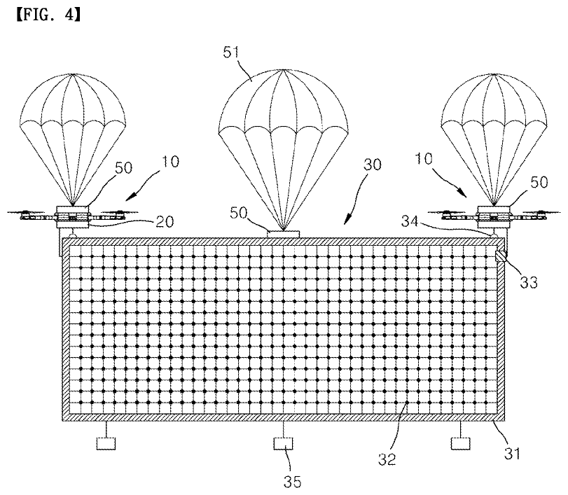

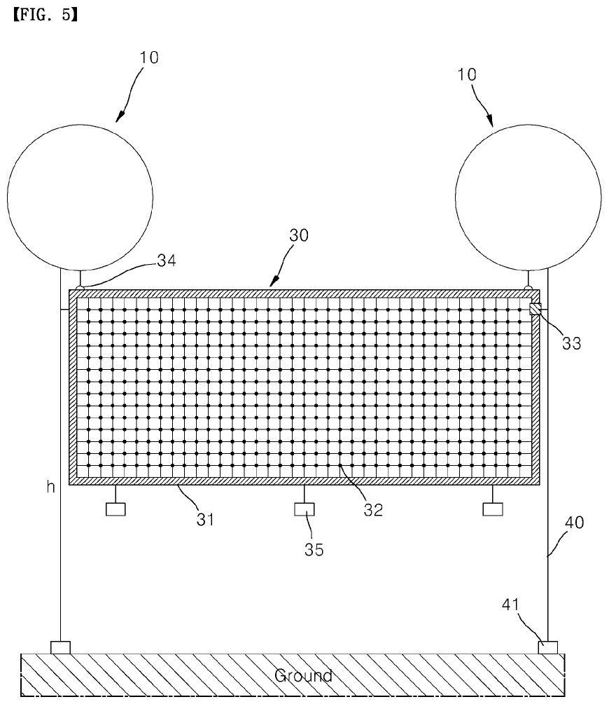

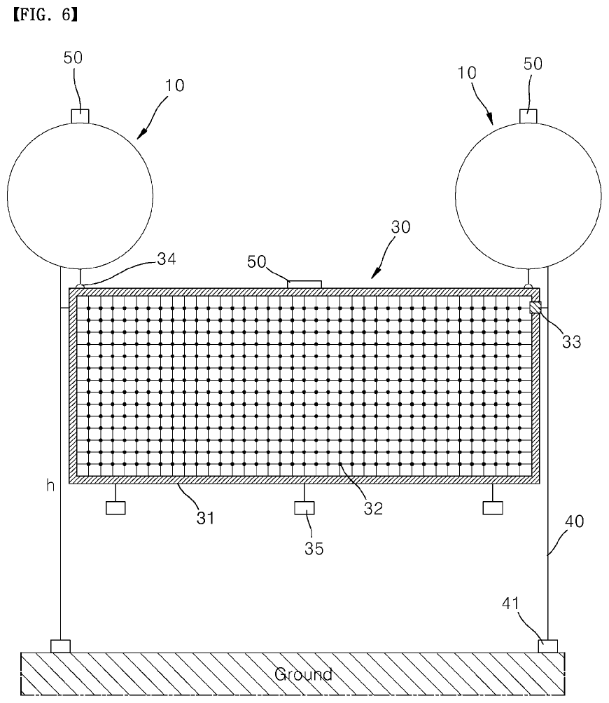

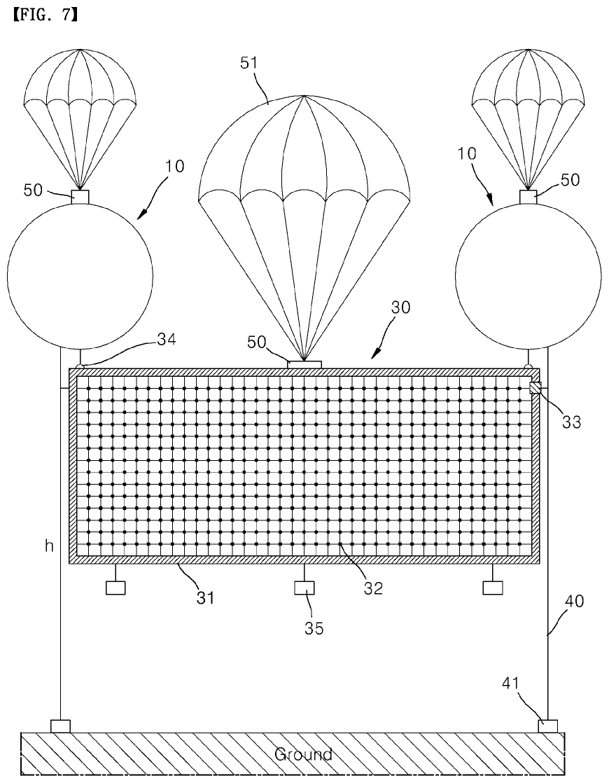

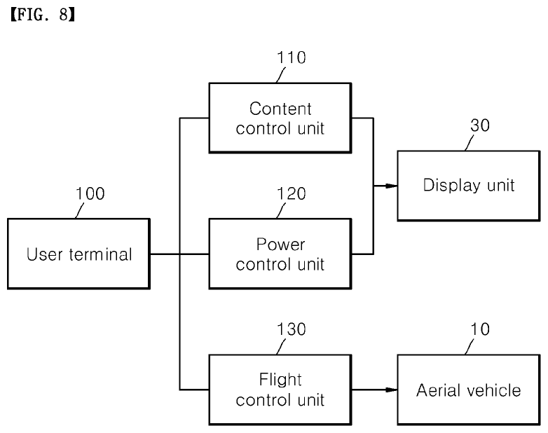

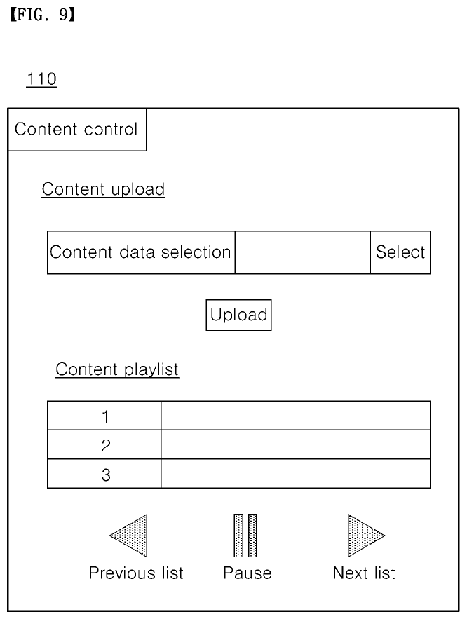

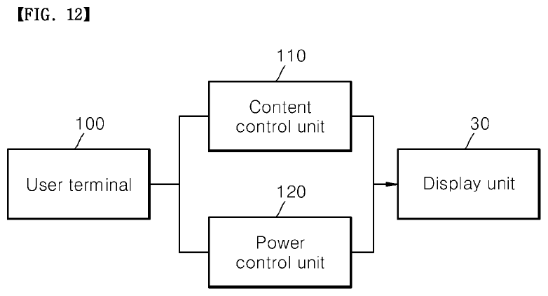

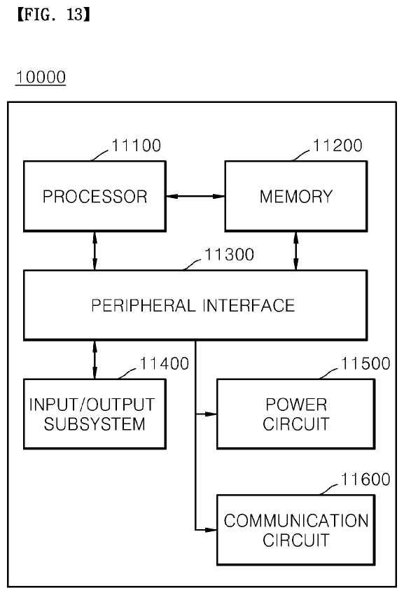

Briefly reviewing the accompanying drawings as descriptions of the present invention, FIG. 1 shows an example of a schematic shape of a floating electronic display board using an aerial vehicle capable of operating in an unmanned manner, FIG. 2 shows an example of a schematic shape of a mesh member of a display unit, and FIGS. 3 and 4 show an example of a state in which a safety device is provided on the floating electronic display board using the aerial vehicle capable of operating in the unmanned manner. In addition, FIG. 5 shows an example of a schematic shape of a floating electronic display board using an aerial vehicle having a balloon shape, FIGS. 6 and 7 show an example of a state in which a safety device is provided on the floating electronic display board using the aerial vehicle having the balloon shape, FIG. 8 is a block diagram showing the floating electronic display board using the aerial vehicle capable of operating in the unmanned manner, which is controlled through a user terminal, FIGS. 9 to 11 show examples of controlling the aerial vehicle and a display unit through a user terminal, FIG. 12 is a block diagram showing the floating electronic display board using the aerial vehicle having the balloon shape, which is controlled through a user terminal, and FIG. 13 shows one example of an internal configuration of a computing device.

Referring to FIG. 1, which shows an example of a schematic shape of a floating electronic display board using an aerial vehicle capable of operating in an unmanned manner according to one embodiment of the present invention, the floating electronic display board using the aerial vehicle capable of operating in the unmanned manner according to the present invention may largely include an aerial vehicle 10, a power supply unit 20, and a display unit 30.

First, the aerial vehicle 10 may be an aerial vehicle capable of operating in an unmanned manner, in which a communication module (not shown), a GPS (not shown), and a power supply device (not shown) are mounted, configured to interwork with a user terminal through the communication module, and capable of moving up, down, left, and right in midair according to manipulation of a user through the user terminal or a preset flight path, and at least two aerial vehicles 10 may be provided.

In this case, the aerial vehicle 10 may be preferably understood as an aerial vehicle capable of operating in an unmanned manner, such as a drone, an airship, or a balloon, and most preferably, a drone may be used as the aerial vehicle 10. Meanwhile, the aerial vehicle 10 may be configured such that the user located on a ground controls the aerial vehicle 10 through wireless communication through the user terminal.

In detail, the aerial vehicle 10 may interwork with the user terminal of the user located on the ground through the communication module mounted in the aerial vehicle 10, and a wireless communication module may be preferably used as the communication module in order to control the aerial vehicle 10 through the wireless communication through the user terminal.

Meanwhile, the power supply unit 20 may be installed in one region of the aerial vehicle 10.

The power supply unit 20 may perform a function of applying a power to the power supply device mounted in the aerial vehicle 10. In this case, a device capable of supplying a power on its own, such as a battery, may be preferably used as the power supply unit 20.

Meanwhile, although not shown in the accompanying drawings, the power supply unit 20 may further include a solar panel, such that a battery of the power supply unit 20 may be charged by using the solar panel to supply an electric power on its own, but the present invention is not limited thereto.

Meanwhile, the display unit 30 may be coupled to one lower region of the aerial vehicle 10.

As shown in FIG. 1, the display unit 30 may be coupled to a lower portion of the aerial vehicle 10, electrically connected to the communication module of the aerial vehicle 10, and configured to receive an electric power from the power supply device to output content, and may include a mesh member 31, an LED module 32, and a control module 33.

In this case, simultaneously referring to FIGS. 1 and 2, the mesh member 31 may include a frame 311 having a preset size, have a mesh structure in which a plurality of vertical lines 312 and a plurality of horizontal lines 313 having conductivity intersect each other at a preset interval (e.g., 20 mm) within the frame 311, and include a plurality of grid points 314 formed at points in which the vertical lines 312 and the horizontal lines 313 intersect each other.

Meanwhile, the mesh member 31 may be preferably formed of at least one conductive fiber among a metal fiber, a nanofiber, a conductive metal compound fiber, and a conductive polymer fiber. Accordingly, since the vertical lines 312 and the horizontal lines 313 having conductivity intersect each other to form the mesh member 31 having the mesh structure, the mesh member 31 may perform the same function as a circuit board.

Meanwhile, the LED module 32 may be coupled to each of the grid points 314 formed in the mesh member 31.

The LED module 32 may emit light on its own, and each of LED modules 32 may implement a pixel, so that a display may be formed through a plurality of the LED modules 32. The display, that is, an electronic display board, may be formed by coupling the LED module 32 to the mesh member 31 formed of the conductive fiber, so that the display may be lightweight.

Meanwhile, a micro-LED may be used instead of the LED module 32, but the present invention is not limited thereto.

Meanwhile, the number of grid points 314 formed in the mesh member 31 may be determined according to the interval at which the vertical lines 312 and the horizontal lines 313 of the mesh member 31 are arranged, the number of LED modules 32 coupled to the grid points 314 of the mesh member 31 may be determined according to the number of grid points 314, and pixels and image quality of the display unit 30 may be determined according to the number of LED modules 32.

Therefore, an overall size of the mesh member 31 may be preferably set such that horizontal and vertical lengths of the mesh member 31 is 20 to 30 m, and the interval at which the vertical lines 312 and the horizontal lines 313 are arranged may be preferably set to form the mesh member 31 such that horizontal and vertical intervals are equal to each other, in which each of the intervals is 10 to 30 mm.

In addition, most preferably, the interval at which the vertical lines 312 and the horizontal lines 313 of the mesh member 31 are arranged may be 20 mm, so that when the display unit 30 floats in the midair, the content may be output in high quality as compared with a height of the midair in which the display unit 30 is arranged.

Meanwhile, the overall size of the mesh member 31 and the interval at which the vertical lines 312 and the horizontal lines 313 are arranged may be changed according to the needs of the user, but the present invention is not limited thereto.

Meanwhile, although not shown in the accompanying drawings, the display unit 30 may further include a protective film (not shown) for protecting the LED module 32 coupled to the mesh member 31.

The protective film may be a device having the same size as the mesh member 31 to protect a front surface of the mesh member 31 to which the LED module 32 is coupled, the protective film may have the same size as the mesh member 31, and an LED module insertion groove (not shown) into which the LED module 32 coupled to the mesh member 31 may be inserted is formed on a surface of the protective film adjacent to the mesh member 31.

In this case, the LED module insertion groove may be configured such that the number of LED module insertion grooves is equal to the number of LED modules 32 coupled to the grid points 314 formed in the mesh member 31, respectively, and an interval at which the LED module insertion grooves are formed is equal to an interval at which the LED modules 32 are coupled to the mesh member 31, and a depth of the LED module insertion groove may preferably correspond to a height of the LED module 32 coupled to the mesh member 31 to protrude outward.

Accordingly, since the protective film is installed on the display unit 30, the protective film may perform a function of protecting the electronic display board coupled to the aerial vehicle to float in the midair from external contaminants, so that a lifespan of the electronic display board may be extended.

Meanwhile, the display unit 30 may include a control module 33, in which the control module 33 may be connected to the communication module of the aerial vehicle 10, and configured to receive content data from the communication module to control output of the content data to the LED module 32.

In this case, as shown in FIG. 1, the control module 33 may be installed in one region of the frame 311 of the mesh member 31, and connected to the communication module of the aerial vehicle 10.

In detail, the communication module may receive the content data through the user terminal interworking with the communication module mounted in the aerial vehicle 10, and when the communication module transmits the content data to the control module 33, the control module 33 may receive the content data to perform control to output the content data to the LED module 32.

Meanwhile, the display unit 30 may further include a weight object 35.

The weight object 35 may perform a function of absorbing a vibration generated in the display unit 30 when the display unit 30 floats in the midair, a plurality of weight objects 35 may be provided, and the weight object 35 may be coupled to a bottom portion of the display unit 30, that is, a bottom portion of the frame of the mesh member 31, at a preset interval.

Since the weight object 35 is coupled to the bottom portion of the frame, the weight object 35 may absorb the vibration generated in the display unit 30, thereby assisting in smoothly supplying the electric power applied to the display unit 30.

In this case, the weight object 35 may be preferably provided as a weight object having a weight that does not cause deformation of a shape of the display unit 30, and a shape and a size of the weight object 35 and the number of weight objects 35 may be changed as needed, but the present invention is not limited thereto.

Meanwhile, according to one embodiment of the present invention, as shown in FIG. 1, three weight objects 35 may be provided and coupled to the bottom portion of the frame 311 of the mesh member 31 at equidistant intervals, so that the vibration of the display unit 30 may be absorbed, and a shape of the mesh member 31 formed of the conductive fiber may be prevented from being deformed, and thus an electric power may be smoothly supplied to the LED modules 32 coupled to the grid points 314 formed in the mesh member 31 from the power supply unit 20 so as to operate the LED modules 32.

In addition, when the mesh member 31 of the display unit 30 floats in the midair, the weight object 35 may prevent the mesh member 31 from being distorted by a wind direction, thereby assisting in smoothly identifying the content output from the display unit 30.

In this case, the number of weight objects 35 may be changed according to a size of the display unit 30, but the present invention is not limited thereto.

Meanwhile, the display unit 30 may include an aerial vehicle fastening part 34 formed to allow the display unit to be coupled to the aerial vehicle 10.

As shown in FIG. 1, at least two aerial vehicle fastening parts 34 may be formed on an upper portion of the mesh member 31 of the display unit 30 at equidistant intervals based on an entire length of the upper portion of the mesh member 31 such that the number of aerial vehicle fastening parts 34 corresponds to the number of aerial vehicles 10.

In this case, according to one embodiment of the present invention, when two aerial vehicles 10 are provided, the aerial vehicles 10 may be preferably coupled to two aerial vehicle fastening parts 34 formed at both ends of the upper portion of the mesh member 31 such that the number of aerial vehicle fastening parts 34 corresponds to the number of aerial vehicles 10, respectively, so that the display unit 30 floats in the midair, and when more than two aerial vehicles 10 are provided, the aerial vehicles 10 may be preferably coupled to aerial vehicle fastening parts 34 formed on the upper portion of the mesh member 31 at equidistant intervals such that the number of aerial vehicle fastening parts 34 corresponds to the number of aerial vehicles 10, respectively, so that the display unit 30 floats in the midair.

Meanwhile, although not shown in the accompanying drawings, a display fastening part (not shown) coupled to the aerial vehicle fastening part 34 of the display unit 30 to allow the display unit 30 to be coupled to the aerial vehicle 10 may be formed in one lower region of the aerial vehicle 10.

In this case, the aerial vehicle fastening part 34 and the display fastening part may be coupled to each other to safely fix the display unit 30 to the lower portion of the aerial vehicle 10, so that the display unit 30 may stably float in the midair when the aerial vehicle 10 flies, and any coupling scheme capable of stably fixing the display unit 30 to the aerial vehicle 10 may be used as a scheme of coupling the aerial vehicle 10 and the display unit 30 to each other, but the present invention is not limited thereto.

Meanwhile, the floating electronic display board using the aerial vehicle according to the present invention may further include a safety device 50 provided on the aerial vehicle 10 and the display unit 30 to prevent a fall accident of at least one of the aerial vehicle 10 and the display unit 30.

According to one embodiment of the present invention, as shown in FIGS. 3 and 4, the safety device 50 may be provided in one region of the aerial vehicle 10 and one region of the display unit 30, in which the safety device 50 may be preferably installed in each of one region of a top of the aerial vehicle 10 and one region of a top of the display unit 30.

In this case, the safety device 50 may include: a parachute 51 compressed by an elastic device (e.g., a spring), and accommodated in a housing; an atmospheric pressure sensor (not shown) configured to measure an altitude of the aerial vehicle 10 or the display unit 30; and an acceleration sensor (not shown) configured to measure an acceleration of the aerial vehicle 10 or the display unit 30.

Accordingly, the safety device 50 may detect a fall of the aerial vehicle 10 or the display unit 30 through measurement values of the atmospheric pressure sensor and the acceleration sensor, and unfold the parachute 51 when the altitude measured through the atmospheric pressure sensor reaches a preset altitude.

In detail, an atmospheric pressure of the atmosphere in which the aerial vehicle 10 or the display unit 30 is currently located may be measured through the atmospheric pressure sensor, so that the altitude at which the aerial vehicle 10 or the display unit 30 is currently located may be measured, and the acceleration with which the aerial vehicle 10 or the display unit 30 moves may be measured through the acceleration sensor.

Therefore, when a sudden change occurs in the measurement value based on the measurement values of the altitude and the acceleration of the aerial vehicle 10 or the display unit 30, which are measured through the atmospheric pressure sensor and the acceleration sensor, a fall state of the aerial vehicle 10 or the display unit 30 may be preferably determined and detected.

In addition, in a case where the fall of the aerial vehicle 10 or the display unit 30 is detected, when the altitude measured by the atmospheric pressure sensor reaches the preset altitude, the parachute 51 compressed by the elastic device in the housing may be unfolded so that the fall accident may be prevented, and when the aerial vehicle 10 or the display unit 30 falls, the aerial vehicle 10 or the display unit 30 may safely land on the ground through the parachute so that a safety accident may be prevented.

Meanwhile, as shown in FIG. 8, the floating electronic display board using the aerial vehicle capable of operating in the unmanned manner according to the present invention may control the aerial vehicle 10 and the display unit 30 through a user terminal 100 interworking with the communication module mounted in the aerial vehicle 10.

In this case, the user terminal 100 may control the aerial vehicle 10 and the display unit 30 by communicating with the communication module mounted in the aerial vehicle 10, and may include a content control unit 110, a power control unit 120, and a flight control unit 130.

The content control unit 110 may perform control to transmit content data, which is to be output from the display unit 30, to the communication module, and the power control unit 120 may control a power of the display unit 30 by controlling the power supply device mounted in the aerial vehicle 10. Accordingly, the display unit 30 may be controlled by controlling the power of the display unit 30 through the power control unit 120, and transmitting the content, which is to be output from the display unit 30, to the communication module through the content control unit 110.

In addition, the flight control unit 130 may set a flight path or manipulate the flight path of the aerial vehicle 10 in real time by controlling the GPS mounted in the aerial vehicle 10, thereby manipulating the aerial vehicle 10.

Meanwhile, according to one embodiment of the present invention, as shown in FIG. 9, the user terminal 100 may select the content data, which is to be output from the display unit 30, through the content control unit 110 and upload the content data to the communication module, a playlist of content currently being played on the display unit 30 may be checked in the user terminal 100, and the user terminal 100 may perform control to pause the content being output from the display unit 30, or output content of a previous list and content of a next list in the content playlist, but the present invention is not limited thereto.

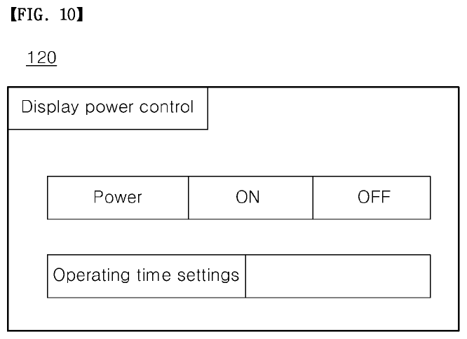

In addition, according to one embodiment of the present invention, as shown in FIG. 10, the user terminal 100 may control the power of the display unit 30 through the power control unit 120, and may set an operating time so as to perform control to output the content by supplying the power to the display unit 30 for a preset time, but the present invention is not limited thereto.

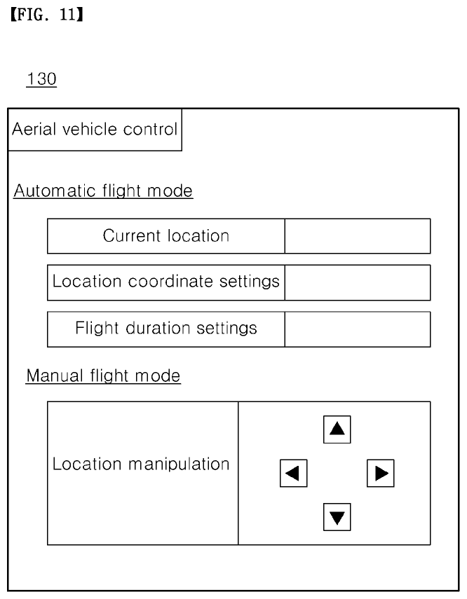

In addition, according to one embodiment of the present invention, as shown in FIG. 11, the user terminal 100 may determine a current location through the GPS mounted in the aerial vehicle 10, location coordinates at which the aerial vehicle 10 is to be located may be set through the flight control unit 130 of the user terminal 100, and location coordinate values may be transmitted to the GPS of the aerial vehicle 10, so that the aerial vehicle 10 may automatically fly according to the preset flight path. In addition, a flight duration of the aerial vehicle 10 may be set through the user terminal 100, so that a duration in which the aerial vehicle 10 flies in the midair may be manipulated, but the present invention is not limited thereto.

In addition, the flight control unit 130 may manipulate the flight path of the aerial vehicle 10 in real time. In this case, a location manipulation button formed on the user terminal 100 may manually allow the aerial vehicle 10 to fly, or a location of the aerial vehicle 10 may be manipulated in real time by using an additional controller (not shown) for manipulating the location of the aerial vehicle 10, but the present invention is not limited thereto.

Next, hereinafter, a floating electronic display board using an aerial vehicle having a balloon shape according to another embodiment of the present invention will be described with reference to FIGS. 5 to 7.

In detail, as shown in FIG. 5, the floating electronic display board using the aerial vehicle having the balloon shape described in the present disclosure may include an aerial vehicle 10, a cable 40, and a display unit 30 as main components.

In this case, the aerial vehicle 10 may be an aerial vehicle having a balloon shape, in which a communication module (not shown), a GPS (not shown), and a power supply device (not shown) are mounted, configured to interwork with a user terminal through the communication module, and having a balloon shape so as to be filled with a gas so that the aerial vehicle may float in midair, and at least two aerial vehicles 10 may be provided.

Meanwhile, a gas balloon filled with a gas to float in midair, such as a balloon or an advertising balloon, may be preferably used as the aerial vehicle 10, and most preferably, a balloon may be used as the aerial vehicle 10. The gas used in the aerial vehicle 10 may be preferably one gas among helium and hydrogen, which are lighter than air.

Meanwhile, although not shown in the accompanying drawings, the aerial vehicle 10 having the balloon shape may further include a gas adjustment unit (not shown) configured to adjust an amount of the gas with which the aerial vehicle 10 is filled, but the present invention is not limited thereto.

In this case, the gas adjustment unit may be installed in one region of the aerial vehicle 10, and the amount of the gas with which the aerial vehicle 10 is filled may be adjusted through the gas adjustment unit, so that the aerial vehicle 10 may stably float in the midair, and thus the aerial vehicle 10 may be prevented from falling, being damaged, and colliding.

Meanwhile, the cable 40 may be coupled to the aerial vehicle 10 to fix the aerial vehicle 10 such that the aerial vehicle 10 is spaced apart from a ground by a preset distance h.

In this case, the cable 40 may be coupled between the ground and the aerial vehicle 10 to apply an external power 41 to the power supply device mounted in the aerial vehicle 10 from the ground.

Meanwhile, the display unit 30 may be coupled to a lower portion of the aerial vehicle 10. In this case, the display unit 30 may have the same configuration as the display unit 30 of the floating electronic display board using the aerial vehicle capable of operating in the unmanned manner described above, but there may be some differences in how the power is supplied.

In other words, there is a difference in that, in a case of the display unit 30 of the floating electronic display board using the aerial vehicle capable of operating in the unmanned manner described above, when the power is applied from the power supply unit 20 installed in one region of the aerial vehicle 10 to the power supply device mounted in the aerial vehicle 10, the power supply device may supply the electric power to the display unit 30 of the floating electronic display board using the aerial vehicle capable of operating in the unmanned manner, whereas in a case of the display unit 30 of the floating electronic display board using the aerial vehicle having the balloon shape, the external power 41 may be applied from the ground to the power supply device mounted in the aerial vehicle 10 through the cable 40 coupled between the ground and the aerial vehicle 10, and the power supply device may supply the electric power to the display unit 30.

Accordingly, the display unit 30 having the same configuration as the display unit 30 of the floating electronic display board using the aerial vehicle capable of operating in the unmanned manner described above may be coupled to the lower portion of the aerial vehicle 10 having the balloon shape, electrically connected to the communication module of the aerial vehicle 10, and configured to receive an electric power from the power supply device to which the external power 41 is applied from the ground to output content.

In addition, similar to the display unit 30 of the floating electronic display board using the aerial vehicle capable of operating in the unmanned manner described above, the display unit 30 of the floating electronic display board using the aerial vehicle having the balloon shape may include a mesh member 31, an LED module 32, a control module 33, and an aerial vehicle fastening part 34, and may further include a weight object 35, and functions and effects of components may be understood as being the same as the functions and effects of the components described above, respectively.

Meanwhile, according to another embodiment of the present invention, the floating electronic display board using the aerial vehicle having the balloon shape may further include a safety device 50 having the same configuration as the safety device 50 of the floating electronic display board using the aerial vehicle capable of operating in the unmanned manner described above.

As shown in FIGS. 6 and 7, the safety device 50 may be provided on the aerial vehicle 10 and the display unit 30, in which the safety device 50 may be preferably installed in each of one region of a top of the aerial vehicle 10 and one region of a top of the display unit 30.

In this case, similar to the safety device 50 of the floating electronic display board using the aerial vehicle capable of operating in the unmanned manner described above, the safety device 50 of the floating electronic display board using the aerial vehicle having the balloon shape may include a parachute 51, an atmospheric pressure sensor (not shown), and an acceleration sensor (not shown), and functions and effects of components may be understood as being the same as the functions and effects of the components described above, respectively.

Meanwhile, according to another embodiment of the present invention, as shown in FIG. 12, the floating electronic display board using the aerial vehicle having the balloon shape may control the aerial vehicle 10 and the display unit 30 through a user terminal 100 interworking with the communication module mounted in the aerial vehicle 10.

In this case, the user terminal 100 may control the display unit 30 by communicating with the communication module mounted in the aerial vehicle 10, and may include a content control unit 110 and a power control unit 120.

The content control unit 110 may perform control to transmit content data, which is to be output from the display unit 30, to the communication module, and the power control unit 120 may control a power of the display unit 30 by controlling the power supply device mounted in the aerial vehicle 10. Accordingly, the display unit 30 may be controlled by controlling the power of the display unit 30 through the power control unit 120, and transmitting the content, which is to be output from the display unit 30, to the communication module through the content control unit 110.

Meanwhile, according to another embodiment of the present invention, as shown in FIG. 9, the user terminal 100 may select the content data, which is to be output from the display unit 30, through the content control unit 110 and upload the content data to the communication module, a playlist of content currently being played on the display unit 30 may be checked in the user terminal 100, and the user terminal 100 may perform control to pause the content being output from the display unit 30, or output content of a previous list and content of a next list in the content playlist, but the present invention is not limited thereto.

In addition, according to another embodiment of the present invention, as shown in FIG. 10, the user terminal 100 may control the power of the display unit 30 by controlling the power supply device mounted in the aerial vehicle 10 to receive the external power from the ground through the power control unit 120, and an operating time of the display unit 30 may be set in the user terminal 100 so as to perform control to output the content by supplying the power to the display unit 30 for a preset time, but the present invention is not limited thereto.

Meanwhile, according to still another embodiment of the present invention, a manned aerial vehicle may also be used as the aerial vehicle 10, but the present invention is not limited thereto. In addition, when the manned aerial vehicle is used as the aerial vehicle 10, the aerial vehicle 10 may move according to manipulation of a pilot riding the aerial vehicle 10, so that the display unit 30 coupled to the aerial vehicle 10 may be moved.

Therefore, when the manned aerial vehicle is used as the aerial vehicle 10, the aerial vehicle 10 and the display unit 30 may be preferably moved according to real-time manipulation of the pilot riding the aerial vehicle 10, since the pilot directly rides the aerial vehicle 10, a location of the display unit 30 floating in the midair may be more precisely controlled, and since the aerial vehicle 10 is controlled in real time, when an emergency situation such as a fall or a communication problem occurs, the pilot riding the aerial vehicle 10 may more rapidly handle the emergency situation.

Overall, according to the embodiment of the present invention described above, according to a floating electronic display board using an aerial vehicle of the present invention, a large electronic display board may be coupled to a remotely-controlled or autonomously-flying unmanned aerial vehicle so as to be arranged in midair, so that an advertisement and content may be output in the midair within a large space, and thus the electronic display board may be exposed without space restrictions, which may allow a plurality of persons to be effectively exposed to the advertisement and the content output from the electronic display board, thereby enabling smooth information transmission.

In addition, according to one embodiment of the present invention, a lightweight electronic display board may be provided by using a display having a mesh structure, so that flight of an aerial vehicle may be prevented from being restricted by a weight of the display coupled to the aerial vehicle, a size of the display may be prevented from being limited, or the display may be prevented from being separated to fall from the aerial vehicle.

Although the embodiments have been described above with specific embodiments and drawings, various modifications and changes can be made by a person having ordinary skill in the art from the above description.

Next, referring to FIG. 13, FIG. 13 shows one example of an internal configuration of a computing device according to one embodiment of the present invention. In the following description, redundant descriptions of the embodiments corresponding to the above descriptions of FIGS. 1 to 12 will be omitted.

As shown in FIG. 13, a computing device 10000 may at least include at least one processor 11100, a memory 11200, a peripheral interface 11300, an input/output (I/O) subsystem 11400, a power circuit 11500, and a communication circuit 11600. In this case, the computing device 10000 may correspond to a user terminal A connected to a tactile interface device, or correspond to a computing device B described above.

The memory 11200 may include, for example, a high-speed random access memory, a magnetic disk, an SRAM, a DRAM, a ROM, a flash memory, or a non-volatile memory. The memory 11200 may include a software module, an instruction set, or other various data required for an operation of the computing device 10000.

In this case, access to the memory 11200 from other components such as the processor 11100 or the peripheral interface 11300 may be controlled by the processor 11100.

The peripheral interface 11300 may couple an input and/or output peripheral device of the computing device 10000 to the processor 11100 and the memory 11200. The processor 11100 may execute the software module or the instruction set stored in the memory 11200 to perform various functions for the computing device 10000 and process data.

The I/O subsystem 11400 may couple various input/output peripheral devices to the peripheral interface 11300. For example, the I/O subsystem 11400 may include a controller for coupling the peripheral device, such as a monitor, a keyboard, a mouse, a printer, or a touch screen or a sensor if necessary, to the peripheral interface 11300. According to another aspect, input/output peripheral devices may be coupled to the peripheral interface 11300 without passing through the I/O subsystem 11400.

The power circuit 11500 may supply a power to all or some of the components of the terminal. For example, the power circuit 11500 may include a power management system, at least one power source such as a battery or an alternating current (AC), a charging system, a power failure detection circuit, a power converter or inverter, a power status indicator, or any other components for generating, managing, or distributing a power.

The communication circuit 11600 may use at least one external port to enable communication with other computing devices.

Alternatively, as described above, the communication circuit 11600 may include an RF circuit, if necessary, to transmit and receive an RF signal, which is also known as an electromagnetic signal, thereby enabling the communication with other computing devices.

The above embodiment of FIG. 13 is merely one example of the computing device 10000, and the computing device 10000 may have a configuration or arrangement that omits some of the components shown in FIG. 13, further includes an additional component that is not shown in FIG. 13, or combines at least two components. For example, a computing device for a communication terminal in a mobile environment may further include a touch screen, a sensor, or the like in addition to the components shown in FIG. 13, and the communication circuit 11600 may include a circuit for RF communication in various communication schemes (Wi-Fi, 3G, LTE, Bluetooth, NFC, Zigbee, etc.). The components that may be included in the computing device 10000 may be implemented as hardware, software, or a combination of both hardware and software including at least one integrated circuit specialized in signal processing or an application.

The methods according to the embodiments of the present invention may be implemented in the form of program instructions that may be executed through various computing devices, and may be recorded in a computer-readable medium. In particular, a program according to the present embodiment may be configured as a PC-based program or an application dedicated to a mobile terminal. An application to which the present invention is applied may be installed in a user terminal through a file provided by a file distribution system. For example, the file distribution system may include a file transmission unit (not shown) for transmitting the file according to a request from the user terminal.

The device described above may be implemented as a hardware component, a software component, and/or a combination of the hardware component and the software component. For example, the devices and components described in the embodiments may be implemented by using at least one general-purpose or special-purpose computer such as a processor, controller, an arithmetic logic unit (ALU), a digital signal processor, a microcomputer, a field programmable gate array (FPGA), a programmable logic unit (PLU), a microprocessor, or any other device capable of executing and responding to an instruction. A processing device may execute an operating system (OS) and at least one software application executed on the operating system. In addition, the processing device may access, store, manipulate, process, and generate data in response to the execution of the software. In some cases, one processing device has been described as being used for convenience of understanding. However, it will be appreciated by a person having ordinary skill in the art that the processing device may include a plurality of processing elements and/or a plurality of types of processing elements. For example, the processing device may include a plurality of processors or one processor, and one controller. In addition, other processing configurations such as a parallel processor are also possible.

The software may include a computer program, a code, an instruction, or a combination of at least one thereof, and may configure the processing device to operate as desired or instruct the processing device independently or collectively. In order for the software and/or data to be interpreted by the processing device or to provide an instruction or data to the processing device, the software and/or data may be permanently or temporarily embodied in any type of machine, component, physical device, virtual equipment, computer storage medium, or device. The software may be distributed over computing devices, which are connected through a network, so as to be stored or executed in a distributed manner. The software and data may be stored in at least one computer-readable recording medium.

The method according to the embodiment may be implemented in the form of a program instruction that may be executed through various computer devices, and may be recorded in a computer-readable medium. The computer-readable medium may include a program instruction, a data file, a data structure, and the like, alone or in combination with each other. The program instruction recorded in the medium may be specially designed and configured for the embodiment, or may be publicly known and available to a person having ordinary skill in the art of computer software. An example of the computer-readable recording medium includes magnetic media such as a hard disk, a floppy disk, and a magnetic tape, optical media such as a CD-ROM and a DVD, magneto-optical media such as a floptical disk, and a hardware device specially configured to store and execute a program instruction, such as a ROM, a RAM, and a flash memory. An example of the program instruction includes a high-level language code that may be executed by a computer by using an interpreter or the like, as well as a machine language code generated by a compiler. The hardware device may be configured to operate as at least one software module to perform the operations of the embodiments, and vice versa.

Although the floating electronic display board using the aerial vehicle proposed in the present invention has been described above, the idea of the present invention is not limited to the embodiments presented in the present disclosure. In addition, those skilled in the art who understand the idea of the present invention will be able to easily propose other embodiments through supplement, change, removal, addition, and the like of elements within the scope of the same idea, and these embodiments will also fall within the scope of the idea of the present invention.

In addition, since the term such as “include”, “comprise”, or “have” described above means that the corresponding element may be inherent unless explicitly stated to the contrary, it is to be interpreted that other elements may be further included but not excluded. Unless defined otherwise, all terms, including technical and scientific terms, have the same meaning as those commonly understood by a person having ordinary skill in the art to which the present invention pertains. Any terms that are generally used, such as terms defined in dictionaries, are to be interpreted to have the meanings consistent with the contextual meanings in the relevant field of art, and are not to be interpreted to have idealistic or excessively formalistic meanings unless explicitly defined in the present invention.

The above description is merely an illustrative description of the technical idea of the present invention, and various modifications and changes can be made by a person having ordinary skill in the art to which the present invention pertains without departing from the essential characteristics of the present invention. Therefore, the embodiments described in the present disclosure are not intended to limit the technical idea of the present invention, but are provided in a descriptive sense, and the scope of the technical idea of the present invention is not limited by the embodiments. The scope of the present invention is to be interpreted by the appended claims, and construed as encompassing all technical ideas within the scope of equivalents thereof.

What is claimed is:

1. A floating electronic display board using an aerial vehicle capable of operating in an unmanned manner, the floating electronic display board comprising:
at least two aerial vehicles capable of operating in an unmanned manner, in which a communication module, a GPS, and a power supply device are mounted, configured to interwork with a user terminal through the communication module, and capable of moving up, down, left, and right in midair according to manipulation of a user through the user terminal or a preset flight path;
a power supply unit installed in one region of the aerial vehicle to apply a power to the power supply device; and
a display unit coupled to a lower portion of the aerial vehicle, electrically connected to the communication module of the aerial vehicle, and configured to receive an electric power from the power supply device to output content.

2. A floating electronic display board using an aerial vehicle having a balloon shape, the floating electronic display board comprising:
at least two aerial vehicles in which a communication module, a GPS, and a power supply device are mounted, configured to interwork with a user terminal through the communication module, and having a balloon shape so as to be filled with a gas so that the aerial vehicle is able to float in midair;
a cable configured to fix the aerial vehicle such that the aerial vehicle is spaced apart from a ground by a preset distance, and coupled between the ground and the aerial vehicle to apply an external power to the power supply device from the ground; and
a display unit coupled to a lower portion of the aerial vehicle, electrically connected to the communication module of the aerial vehicle, and configured to receive an electric power from the power supply device to output content.

3. The floating electronic display board of claim 1, wherein the display unit includes:
a mesh member including a frame having a preset size, having a mesh structure in which a plurality of vertical lines and a plurality of horizontal lines having conductivity intersect each other at a preset interval within the frame, and including a plurality of grid points formed at points in which the vertical lines and the horizontal lines intersect each other;
an LED module coupled to each of the grid points formed in the mesh member; and
a control module connected to the communication module of the aerial vehicle, and configured to receive content data from the communication module to control output of the content data to the LED module.

4. The floating electronic display board of claim 3, wherein the display unit further includes:
a plurality of weight objects coupled to a bottom portion of the mesh member at a preset interval so as to absorb a vibration generated in the display unit when the display unit floats in the midair.

5. The floating electronic display board of claim 3, wherein the mesh member is formed of at least one conductive fiber among a metal fiber, a nanofiber, a conductive metal compound fiber, and a conductive polymer fiber.

6. The floating electronic display board of claim 3, wherein the display unit further includes:
at least two aerial vehicle fastening parts formed on an upper portion of the mesh member at equidistant intervals based on an entire length of the upper portion of the mesh member such that a number of the aerial vehicle fastening parts corresponds to a number of the aerial vehicles,
when two aerial vehicles are provided, the aerial vehicles are coupled to two aerial vehicle fastening parts formed at both ends of the upper portion of the mesh member, respectively, so that the display unit floats in the midair, and
when more than two aerial vehicles are provided, the aerial vehicles are coupled to aerial vehicle fastening parts formed on the upper portion of the mesh member at equidistant intervals such that a number of the aerial vehicle fastening parts corresponds to the number of the aerial vehicles, respectively, so that the display unit floats in the midair.

7. The floating electronic display board of claim 1, further comprising:
a safety device provided on the aerial vehicle and the display unit to prevent a fall accident of at least one of the aerial vehicle and the display unit.

8. The floating electronic display board of claim 7, wherein the safety device includes:
a parachute compressed by an elastic device, and accommodated in a housing;
an atmospheric pressure sensor configured to measure an altitude of the aerial vehicle or the display unit; and
an acceleration sensor configured to measure an acceleration of the aerial vehicle or the display unit, and
the safety device is configured to detect a fall of the aerial vehicle or the display unit through measurement values of the atmospheric pressure sensor and the acceleration sensor, and unfold the parachute when the altitude measured through the atmospheric pressure sensor reaches a preset altitude.

9. The floating electronic display board of claim 1, wherein the user terminal is configured to control the aerial vehicle and the display unit by communicating with the communication module mounted in the aerial vehicle, and
the user terminal includes:
a content control unit configured to perform control to transmit content data, which is to be output from the display unit, to the communication module;
a power control unit configured to control a power of the display unit by controlling the power supply device mounted in the aerial vehicle; and
a flight control unit configured to set a flight path and manipulate the flight path of the aerial vehicle in real time by controlling the GPS mounted in the aerial vehicle.

10. The floating electronic display board of claim 2, wherein the user terminal is configured to control the display unit by communicating with the communication module mounted in the aerial vehicle, and
the user terminal includes:
a content control unit configured to transmit content data, which is to be output from the display unit, to the communication module; and
a power control unit configured to control a power of the display unit by controlling the power supply device mounted in the aerial vehicle.

11. The floating electronic display board of claim 2, wherein the display unit includes:
a mesh member including a frame having a preset size, having a mesh structure in which a plurality of vertical lines and a plurality of horizontal lines having conductivity intersect each other at a preset interval within the frame, and including a plurality of grid points formed at points in which the vertical lines and the horizontal lines intersect each other;
an LED module coupled to each of the grid points formed in the mesh member; and
a control module connected to the communication module of the aerial vehicle, and configured to receive content data from the communication module to control output of the content data to the LED module.

12. The floating electronic display board of claim 11, wherein the display unit further includes:
a plurality of weight objects coupled to a bottom portion of the mesh member at a preset interval so as to absorb a vibration generated in the display unit when the display unit floats in the midair.

13. The floating electronic display board of claim 11, wherein the mesh member is formed of at least one conductive fiber among a metal fiber, a nanofiber, a conductive metal compound fiber, and a conductive polymer fiber.

14. The floating electronic display board of claim 11, wherein the display unit further includes:
at least two aerial vehicle fastening parts formed on an upper portion of the mesh member at equidistant intervals based on an entire length of the upper portion of the mesh member such that a number of the aerial vehicle fastening parts corresponds to a number of the aerial vehicles,
when two aerial vehicles are provided, the aerial vehicles are coupled to two aerial vehicle fastening parts formed at both ends of the upper portion of the mesh member, respectively, so that the display unit floats in the midair, and
when more than two aerial vehicles are provided, the aerial vehicles are coupled to aerial vehicle fastening parts formed on the upper portion of the mesh member at equidistant intervals such that a number of the aerial vehicle fastening parts corresponds to the number of the aerial vehicles, respectively, so that the display unit floats in the midair.

15. The floating electronic display board of claim 2, further comprising:
a safety device provided on the aerial vehicle and the display unit to prevent a fall accident of at least one of the aerial vehicle and the display unit.

16. The floating electronic display board of claim 15, wherein the safety device includes:
a parachute compressed by an elastic device, and accommodated in a housing;
an atmospheric pressure sensor configured to measure an altitude of the aerial vehicle or the display unit; and
an acceleration sensor configured to measure an acceleration of the aerial vehicle or the display unit, and
the safety device is configured to detect a fall of the aerial vehicle or the display unit through measurement values of the atmospheric pressure sensor and the acceleration sensor, and unfold the parachute when the altitude measured through the atmospheric pressure sensor reaches a preset altitude.
